(19) United States
(12) Patent Application Publication
(10) Pub. No.: US 2011/0266049 A1
(43) Pub. Date: Nov. 3, 2011

(54) DATA CABLE STRUCTURE OF ELECTRONIC DEVICES

(75) Inventors: TUN-YUAN TSOU, Tu-Cheng (TW); KUN-LIN SUNG, Tu-Cheng (TW); CHUNG-YU HUNG, Tu-Cheng (TW)

(73) Assignee: CHI MEI COMMUNICATION SYSTEMS, INC., Tu-Cheng (TW)

(21) Appl. No.: 13/181,649

(22) Filed: Jul. 13, 2011

Related U.S. Application Data
(62) Division of application No. 12/578,973, filed on Oct. 14, 2009.

(30) Foreign Application Priority Data
Apr. 29, 2009 (CN) 200910301967.2

(51) Int. Cl. H02G 11/00

(52) U.S. Cl. 174/70 R

(57) ABSTRACT

A data cable structure includes an interface unit for connecting to electronic devices, a cable unit connected to the interface unit, and a radiation reducing unit mounted on the cable unit. The radiation reducing unit is a winding surrounding a part of the cable unit and cooperating with the cable unit to form a choke structure to prevent electromagnetic radiation generated by the electronic devices from being emitted from the cable unit.

### CROSS-REFERENCE TO RELATED APPLICATION

This application is a divisional application of U.S. Ser. No. 12/578,973, filed on Oct. 14, 2009.

### BACKGROUND

1. Technical Field

The present disclosure relates to data cable structures of electronic devices, and particularly to a radiation reducing data cable structure of electronic devices.

2. Description of Related Art

Portable electronic devices, e.g., mobile phones, personal digital assistants (PDA) and laptop computers, are widely used. Similarly to other electronic devices, portable electronic devices generate electromagnetic radiation when used. Thus, portable electronic devices often have radiation shielding/reducing components installed therein. However, most conventional radiation shielding/reducing components have complicated structures and are large in size, while many portable electronic devices are small with insufficient space to install the radiation shielding/reducing components.

Therefore, there is room for improvement within the art.

### BRIEF DESCRIPTION OF THE DRAWINGS

Many aspects of the present data cable structures of electronic devices can be better understood with reference to the following drawings. The components in the various drawings are not necessarily drawn to scale, the emphasis instead being placed upon clearly illustrating the principles of the present data cable structures of electronic devices. Moreover, in the drawings, like reference numerals designate corresponding parts throughout the figures.

FIG. 1 is a disassembled view of a data cable structure, according to a first exemplary embodiment.

FIG. 2 is an assembled view of the data cable structure shown in FIG. 1.

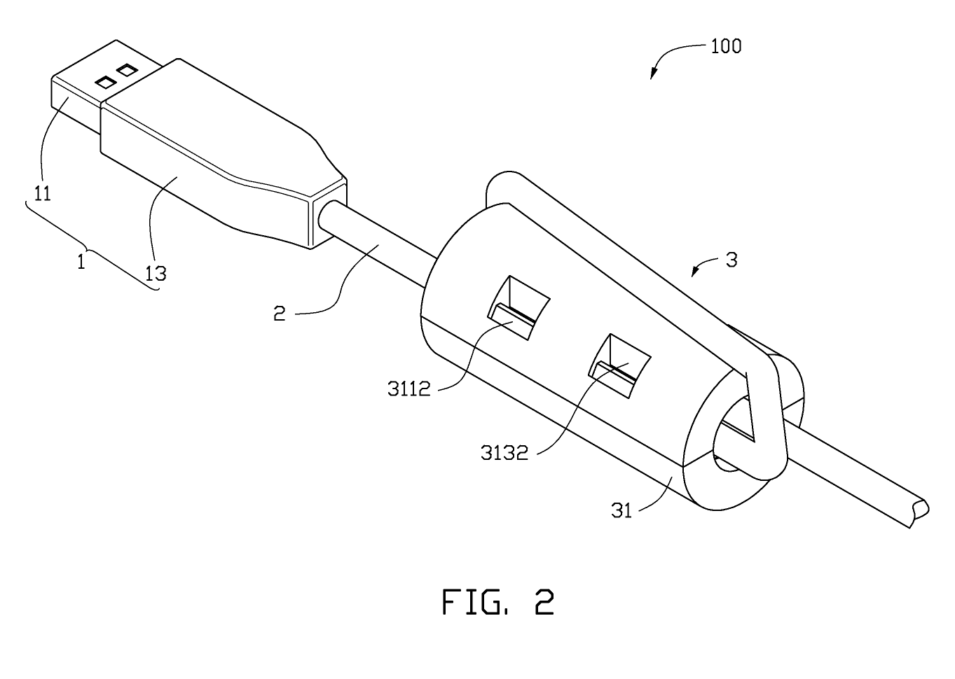

FIG. 3 is similar to FIG. 2, but showing a plurality of choke structures.

FIG. 4 is a schematic, partially cutaway view of a data cable structure, according to a second exemplary embodiment.

### DETAILED DESCRIPTION

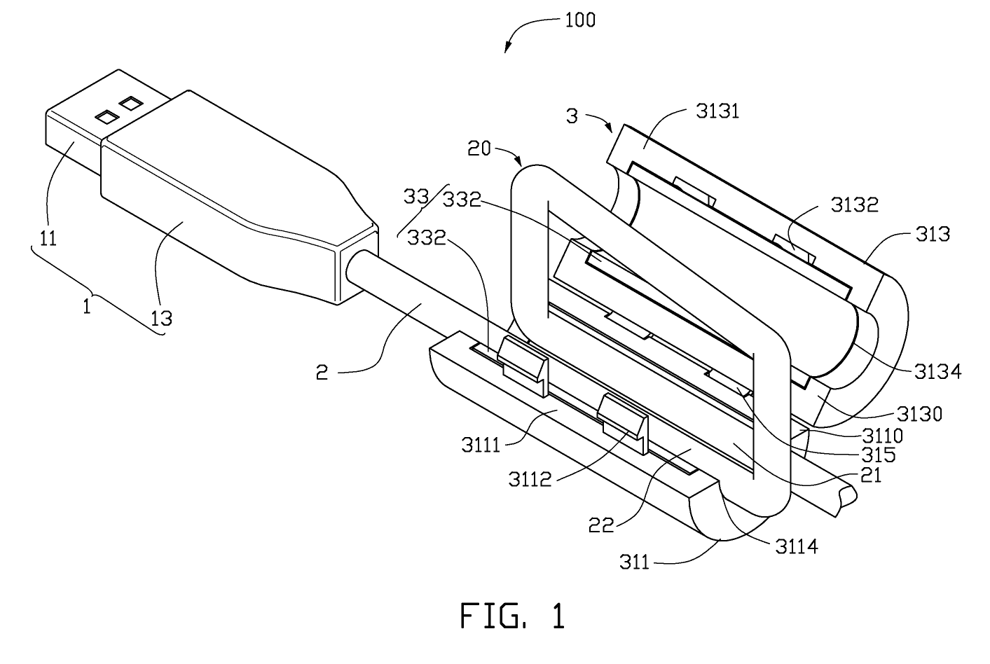

FIG. 1 schematically shows a data cable structure 100 according to a first exemplary embodiment. The data cable structure 100 is used in portable electronic devices (not shown), e.g., mobile phones, personal digital assistants (PDA) and laptop computers, to form electronic connections. The data cable structure 100 includes an interface unit 1, a cable unit 2 and a radiation reducing unit 3.

The interface unit 1 can be a universal serial bus (USB) interface. The interface unit 1 includes a connector unit 11 and an insulating package 13. The connector unit 11 includes at least one electric connector and is partially received in the insulating package 13 and has an end exposing out of the insulating package 13 to connect with electronic devices. The cable unit 2 can be a coaxial cable. One end of the cable unit 2 is received in the insulating package 13 and is connected to the connector unit 11. The other end of the cable unit 2 can be directly connected to an electronic device, and can also be connected to another interface unit 1. A middle portion of the cable unit 2 is coiled to form an approximately rectangular loop 20, which includes two adjacent substantially parallel cable sections 21, 22 positioned on a same side thereof.

The radiation reducing unit 3 includes a protective sleeve barrel 31 and a magnetic component 33. The sleeve barrel 31 is made of insulating materials and includes a first case 311, a second case 313 and a connecting mechanism 315. The first case 311 and the second case 313 are both generally semi-cylindrical casings corresponding to each other. The lengths of the first case 311 and the second case 313 are not more than the lengths of the cable sections 21, 22, such that the first case 311 and the second case 313 can be inserted into the loop 20, with the axis of the first case 311 or the second case 313 positioned substantially parallel to the cable sections 21, 22. The first case 311 includes two rectangular side surfaces 3110, 3111, which are positioned in a same plane. Similarly, the second case 313 includes two rectangular side surfaces 3130, 3131, which are positioned in a same plane. The first case 311 further includes at least one latching hook 3112 formed on the side surface 3111. The second housing 312 defines at least one latching groove 3132 opening on the side surface 3131 and corresponding to the latching hooks 3112. Additionally, the first case 311 defines a first receiving groove 3114 in an inner surface thereof, and the second case 313 defines a second receiving groove 3134 in an inner surface thereof. The first receiving groove 3114 corresponds to the second receiving groove 3134.

The connecting mechanism 315 can be a conventional hinge mechanism. The connecting mechanism 315 is installed between the side surface 3110 of the first case 311 and the side surface 3130 of the second surface 313, such that the first case 311 and the second case 313 are rotatably connected to each other by the connecting mechanism 315. When the side surface 3111 and the side surface 3131 are rotated towards each other, the latching hook(s) 3112 can be inserted into and fixed in corresponding latching groove(s) 3132, and thus the first case 311 and the second case 313 cooperatively form a cylindrical case, i.e., the sleeve barrel 31 is closed.

The magnetic component 33 is made of ferromagnetic materials and includes two semi-cylindrical housings 332, wherein the outer shapes of the two housings 332 respectively correspond to the first receiving groove 3114 and the second receiving grooves 3134. The two housings 332 are respectively received and fixed in the first receiving groove 3114 and the second receiving grooves 3134. When the first case 311 and the second case 313 cooperatively form the cylindrical case, the two housings 332 can cooperatively form a substantially cylindrical magnetic ring.

In assembly, the cable sections 21, 22 are received in either of the two housings 332, and the cable sections 21, 22 are positioned substantially parallel to the axes of the first case 311 and the second case 313. Either of the first case 311 or the second case 313 is rotated to be inserted into the loop 20, and the latching hook(s) 3112 is inserted into corresponding latching grooves 3132 and fixed therein. Thus, the first case 311 and the second case 313 cooperatively form a substantially cylindrical case receiving the two housings 332 and the cable sections 21, 22 therein. The two housings 332 cooperatively form a substantially cylindrical magnetic ring (not labeled), and the magnetic ring surrounds the cable sections 21, 22 to form a choke structure (not labeled). A choke has a reactance in direct proportion to the frequency of the electric signals passing therethrough. Therefore, the choke structure can prevent electric radiations having high frequencies (e.g., in the frequency bands of wireless communication systems) from passing therethrough. In use, the radiation reducing unit 3 can prevent electromagnetic radiation generated by the portable electronic devices connected to the data cable structure 100 from being emitted from the cable unit 2.

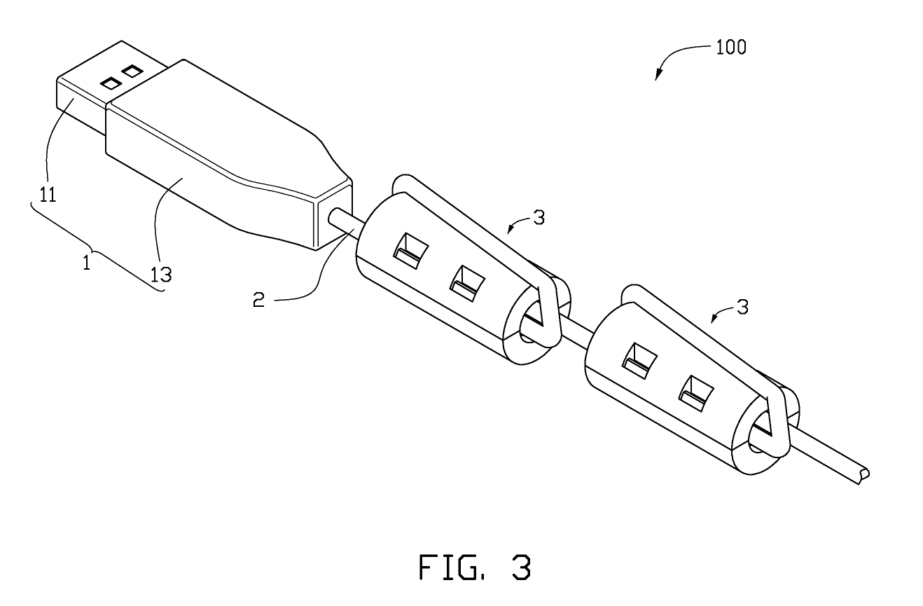

If the position of the radiation reducing unit 3 needs to be changed (e.g., when the magnet component 33 is worn and loses its magnetism), the latching hook(s) 3112 is released from the latching groove(s) 3132, and the first case 311 and the second case 313 with the housings 332 fixed therein are rotated such that the sleeve barrel 31 is opened. The original loop 20 is straightened, and a predetermined portion of the cable unit 2 is coiled to form a new loop 20. Thus, the radiation reducing unit 3 is mounted to the new loop 20 by the aforementioned method to form a new choke structure at the predetermined portion of the cable unit 2. Additionally, as shown in FIG. 3, the data cable structure 100 can further includes a plurality of loops 20 formed by predetermined portions of the cable unit 20 and a plurality of radiation reducing units 3 correspondingly mounted to these loops 20, thereby forming a plurality of choke structures on predetermined portions of the cable unit 20. The loop 20, the sleeve barrel 31 and the magnetic component 33 can also be in other shapes.

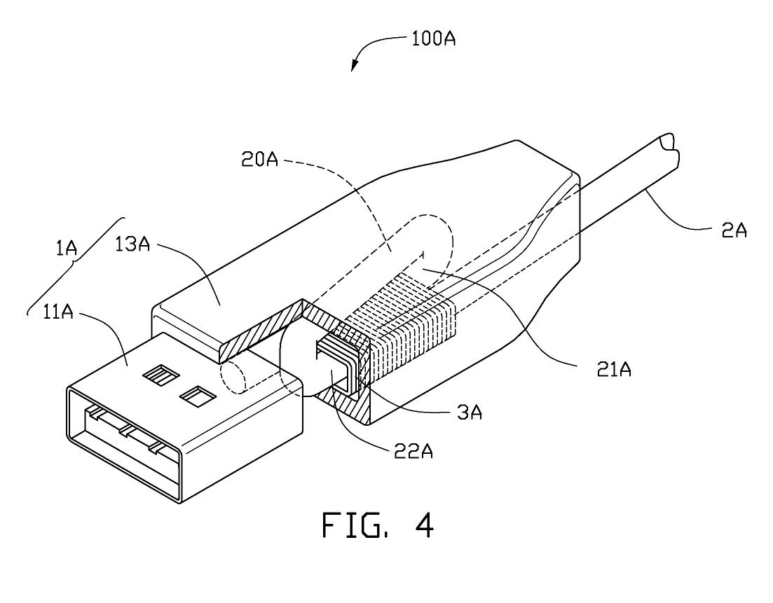

FIG. 4 schematically shows a data cable structure 100A, according to a second exemplary embodiment. The data cable structure 100A includes an interface unit 1A, a cable unit 2A and a radiation reducing unit 3A. The interface unit 1A includes a connector unit 11A and an insulating package 13A. The connector unit 11A and the cable unit 2A are similar to the connector unit 11 and the cable unit 2, correspondingly. The radiation reducing unit 3A is a winding made of ferromagnetic materials. The cable sections 21A, 22A are both surrounded by the radiation reducing unit 3A, thereby forming a choke structure (not labeled). The insulating package 13A entirely packages the loop 20A and the radiation reducing unit 3A therein, and the connector unit 11A is partially received in the insulating package 13A and has an end exposing out of the insulating package 13A to connect electronic devices. Similarly to the choke structure of the data cable structure 100, the choke structure of the data cable structure 100A has a reactance in direct proportion to the frequency of the electric signals passing therethrough, and can prevent electric radiations having high frequencies (e.g., in the frequency bands of wireless communication systems) from passing therethrough. In use, the radiation reducing unit 3A can prevent electromagnetic radiation generated by the electronic devices connected to the data cable structure 100A from being emitted from the cable unit 2A.

The data cable structures 100/100A have chokes integrated therewith, and can prevent electromagnetic radiation generated by the electronic devices connected thereto form being emitted from the cable units 2/2A by the chokes. Thus, the data cable structures 100/100A can replace some conventional radiation reducing components installed in the electronic devices, and the portable electronic devices (especially, portable electronic devices) using the data cable structures 100/100A can be further miniaturized. The present disclosure can also be used in other electronic devices (e.g., televisions, microwave ovens, etc.) for miniaturization.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A data cable structure, comprising:
an interface unit for connecting to electronic devices;
a cable unit connected to the interface unit; and
a radiation reducing unit mounted on the cable unit, wherein the radiation reducing unit is a winding surrounding a part of the cable unit and cooperating with the cable unit to form a choke structure that prevents electromagnetic radiation generated by the electronic devices from being emitted from the cable unit.

2. The data cable structure as claimed in claim 1, wherein the cable unit forms a coiled loop having two substantially parallel cable sections, and the radiation reducing unit surrounds the two cable sections to form the choke structure.

3. The data cable structure as claimed in claim 2, wherein the interface unit includes a connecting unit and an insulating package, the connector unit being partially received in the insulating package and having an end exposing out of the insulating package to connect electronic devices.

4. The data cable structure as claimed in claim 3, wherein the insulating package entirely packages the coiled loop and the radiation reducing unit therein.

5. A data cable structure used in electronic devices to form electronic connections, comprising:
a cable unit; and
a radiation reducing unit mounted on the cable unit, wherein the radiation reducing unit is a winding surrounding a part of the cable unit and cooperating with the cable unit to form a choke structure that prevents electromagnetic radiation generated by the electronic devices from being emitted from the cable unit.

6. The data cable structure as claimed in claim 5, wherein the cable unit forms a coiled loop having two substantially parallel cable sections, and the radiation reducing unit surrounds the two cable sections to form the choke structure.

7. The data cable structure as claimed in claim 6, further comprising an interface unit connected to an end of the cable unit, wherein the interface unit includes a connecting unit and an insulating package, the connector unit being partially received in the insulating package and having an end exposing out of the insulating package to connect electronic devices.

8. The data cable structure as claimed in claim 7, wherein the insulating package entirely packages the coiled loop and the radiation reducing unit therein.
